(19) United States
(12) Patent Application Publication
(10) Pub. No.: US 2010/0006509 A1
(43) Pub. Date: Jan. 14, 2010

(54) MAGNETIC SEPARATION APPARATUS

(75) Inventor: Erik Hornes, Oslo (NO)

Correspondence Address: LIFE TECHNOLOGIES CORPORATION;C/O INTELLEVATE, P.O. BOX 52050, MINNEAPOLIS, MN, 55402, US

(73) Assignee: Invitrogen Dynal AS, Oslo (NO)

(21) Appl. No.: 11/912,501

(22) PCT Filed: Apr. 25, 2006
(86) PCT No.: PCT/GB06/01507

§ 371 Date: Aug. 25, 2008

(30) Foreign Application Priority Data
Apr. 25, 2005 (GB) 0508292.0

(51) Int. Cl. B03C 1/30; B01L 11/00; B01L 3/02

(52) U.S. Cl. 210/695; 422/101; 422/100

(57) ABSTRACT

A magnetic separation device (1) is provided for separating magnetic particles (15) from a liquid (14) in which they are suspended. The magnetic particles will generally have a target substance bonded thereto. The magnetic separation device comprises a chamber (4) having an opening therein. A nozzle (6) may be formed on the chamber with the opening being disposed in the end of the nozzle. The device is arranged to draw liquid into the chamber and expel liquid from the chamber through the opening, by means of, for example, a piston (2) or a vacuum line. The chamber contains a means (8) for separating magnetic particles suspended in the liquid from the liquid, said means comprising a magnetisable element. The magnetisable element may be, for example, a matrix of magnetic spheres. A magnetic separation apparatus (18) comprises a plurality of such magnetic separation devices, and may be automatically operated by an electronic means. A pipette tip (35) is also provided that contains a means (37) for separating magnetic particles suspended in a liquid from the liquid. The means comprises a magnetisable element. Liquid is drawn into and expelled from the pipette tip via an opening in the tip.

The present invention relates to a magnetic separation device for separating magnetic particles from a liquid in which they are suspended. In particular, this invention relates to a magnetic separation device generally in the form of a pipette, pipette tip or syringe which is arranged to draw a liquid into a chamber and subsequently expel the liquid, whilst the magnetic particles are retained in the chamber.

There is a general need in various fields such as the pharmaceutical, medical, agricultural, scientific and engineering fields, to isolate a particular substance from a fluid in which it is contained. For example in biotechnology, it may be desired to isolate immunity substances such as antibodies/antigens, genetic substances such as DNA, RNA, mRNA, biopolymers such as proteins and hormone substances, or organisms such as bacteria, viruses and cells.

A number of different systems that achieve such isolation have been developed, and a particularly successful method utilises magnetic particles. Generally, a target substance contained within a fluid is bonded to magnetic particles by means of, for example, a reactive coating disposed on the particles. The fluid containing the magnetically labelled target substance is then subjected to a magnetic field which exerts a force on the target substance thus allowing it to be separated from the fluid.

One such system is disclosed in WO 90/14891 (Dynal A. S.). A separation device for separating magnetisable particles (having a target substance bonded thereto) from a liquid in which the particles are suspended, is disclosed. The liquid is deposited in a test tube using a pipette, and a strong magnet is arranged adjacent the side walls of the tube. This causes the magnetisable particles to collect along the inner wall of the tube and they are held there whilst the remaining liquid is removed using a pipette.

Precision System Science Co., Ltd have developed a number of similar systems. U.S. Pat. No. 5,702,950 discloses an apparatus comprising a pipette and a sample container. A magnet is disposed adjacent the pipette such that when a sample containing magnetic particles is sucked into the pipette, the particles are held at the wall of the pipette by the magnetic force. The residual liquid can then be expelled from the pipette, with the particles remaining inside the pipette. U.S. Pat. No. 6,509,193 relates to the automation of such a system in order to enhance precision and sensitivity. A control apparatus is provided for controlling the suction/expulsion of fluid and the position of the magnet. In U.S. Pat. No. 6,723,237 separate liquid suction and discharge passages are provided.

It may be desired in some applications, for example combinatorial chemistry, DNA function analysis and automatic measurement of immune substances to process a large number of samples simultaneously. U.S. Pat. No. 6,805,840 discloses an apparatus having a number of pipette chambers contained in a reservoir body and a vessel containing an equal number of liquid-containers. The reservoir body and the vessel can move relative to each other, to allow the pipette nozzles to contact the liquid. A sliding body having a number of pistons is mounted above the reservoir body and can be moved vertically relative to the reservoir body to draw in and expel liquid from the pipette chambers. Projections are formed outside each nozzle and are magnetised by a coil, such that when liquid is sucked into the pipettes, magnetic particles suspended therein adhere to the walls of the nozzles. The residual liquid is then expelled. Various processes such as cleaning can then be carried out by providing alternative vessels carrying different liquids.

U.S. Pat. No. 6,187,270 (Roche) provides a similar system to the Precision System Science systems. A pump is connected to a pipette to draw in and expel fluid, and the pipette is arranged to be moved towards and away from a magnet. The magnet causes the magnetic microparticles suspended in the fluid to separate from the fluid and be deposited on the inner wall of the pipette. The microparticles typically have a diameter between 0.3-5 microns.

An alternative system is disclosed in U.S. Pat. No. 5,837,144 (Boehringer). A magnetic device surrounded by a protective sleeve is immersed in a vessel containing a liquid. The magnetic device may for example comprise bar magnets. Magnetic particles suspended in the liquid are attracted to the magnetic device and adhere to the protective sleeve. An outlet is opened in the base of the vessel to evacuate the liquid, leaving the magnetic particles disposed on the sleeve. WO 96/12958 (Labsystems) discloses a similar device, in which a rod covered in a protective sleeve is inserted into a container of liquid. Magnetised particles adhere to the rod and can be separated by simply removing the rod. The particles typically have a diameter between 1-10 microns.

Yet another alternative method of separating magnetic particles having a target substance adhered thereto from a liquid is described in U.S. Pat. No. 5,385,707. This relates to ‘High Gradient Magnetic Separation’ (HGMS) in which the magnetic particles are separated using a magnetised matrix disposed within a chamber. The matrix is magnetised using a magnet disposed outside the chamber, which intensifies the magnetic gradient within the chamber, thus allowing small, weakly magnetised particles having a typical diameter of 10-200 nm to be separated. In this method, the liquid sample is applied to an inlet at the top of the chamber and flows through the matrix. The magnetic particles are held in the chamber by the matrix and the remaining liquid exits at the bottom of the chamber, whilst the magnetic particles remain in the chamber. The matrix may be made, for example, from magnetically susceptible wires, fibres or particles. This patent particularly relates to the application of a coating to the matrix to prevent corrosion of the matrix and thereby prevent damage to the biological products with which it comes into contact.

U.S. Pat. No. 5,711,871 discloses a similar system to U.S. Pat. No. 5,385,707. However, in US '871 the matrix is not made of wires or fibres since it is recognised that these result in non-uniform pathways which can give variable separation results, and can also trap substances other than the target. Instead, the matrix is made of a uniform lattice of spheres. This produces uniform fluid passages which give a consistent separation result.

U.S. Pat. No. 6,471,860 and U.S. Pat. No. 6,602,422 also relate to HGMS using matrices disposed in the separation chamber. These patents provide an improvement in the shape of the column to allow smaller elution volumes which more efficiently elute smaller samples. The average diameter of the magnetic beads to be retained is 50 nm.

A system in which magnetically labelled cells are modified whilst being retained in a chamber by a matrix is disclosed in U.S. Pat. No. 6,468,432.

In order to save time and resources, it is often desirable to process a large number of samples at once using an automatic separation apparatus, such as that of U.S. Pat. No. 6,805,840 described above. Further, some substances to be separated may be harmful to humans and thus it is preferable that this can be done without direct human intervention. The automation of U.S. Pat. No. 6,805,840 is possible due to the use of pipettes/syringes having only a single opening through which the liquid is drawn in and expelled. However, in this method magnetic particles are separated by an external magnet causing them to be deposited on the inner wall of the pipette. This is only effective with relatively strongly magnetised particles, i.e. larger particles of >1 micron. This is because the magnetic force within the pipette is limited by the magnet being disposed outside of the pipette. The use of smaller and more weakly magnetised particles of (e.g. <1 micron) is however desired in some applications since smaller particles have a larger surface area per gram of particles. They therefore provide a more efficient recovery of the target substance because a greater amount of the substance can be bound per gram of particles.

Known high gradient magnetic separation systems such as those of U.S. Pat. No. 5,385,707 and U.S. Pat. No. 5,711,871 as described above allow smaller, more weakly magnetised particles to be separated through the use of a magnetisable matrix disposed in the chamber. This intensifies the magnetic field gradient in the chamber. However, known systems only utilise such matrices in ‘flow-through’ fluid containers, i.e. those in which the fluid is input at the top of the container, flows through the matrix and exits from the bottom of the container. Such systems are mechanically complex and thus difficult to automise.

Accordingly, there is a need for an automated magnetic separation apparatus that can process a large number of samples containing small, weakly magnetised microparticles.

According to a first aspect, the present invention provides a magnetic separation device comprising a chamber having an opening therein, wherein the device is arranged to draw liquid into the chamber and expel liquid from the chamber through the opening, and wherein the chamber contains a magnetisable element for separating magnetic particles suspended in a liquid from the liquid. Since the magnetisable element used to separate the magnetic particles is within the liquid chamber, it provides a high local magnetic field gradient within the chamber. The force exerted on the particles by this local magnetic field is therefore sufficiently strong that even small, weakly magnetised particles having a diameter of for example <1 micron are retained. The particles may be adsorbed to the surface of the magnetisable element. Further, since liquid is drawn in and expelled through a single opening, the device is sufficiently simple to allow automatic operation.

Although the apparatus can be used to separate any magnetic particles from a liquid, the magnetic particles will generally have a target substance bonded thereto. The target substance may be, for example, DNA, RNA, mRNA, proteins, bacteria, viruses, cells, enzymes, pesticides, hormones or other chemical compounds. The target substance can be bonded to the magnetic particles by coating the particles with a biological binding partner of the target substance and then bringing them into contact with the target substance. The coating may be for example an antigen or antibody that will react with the target substance.

The magnetic particles can be of any shape, including spherical, granular or corpuscular. Preferably, the particles are spherical beads and are made of ferromagnetic, paramagnetic or superparamagnetic material. The beads may have a diameter of one micron or less. Smaller beads provide a more efficient recovery of the target substance because a greater amount of the substance can be bound per gram of the particles. This can be particularly important if the target substance is only present in small quantities or if only a small sample size is available. Furthermore, smaller particles stay in solution longer. Suitable magnetic beads are manufactured by Ademtech, Chemicell, Micromod and Miltenyi.

In one embodiment, the magnetisable element is a magnetisable membrane or filter. It may also be a filamentous element of magnetisable wires or fibres, such as steel wool. It may be a filamentous matrix. However, the use of wires or fibres can cause non-uniform pathways for the liquid through the element, and thus give a variable separation result. Further, they can give rise to the entrapment of substances other than the target. Therefore more preferably, the magnetisable element is a magnetisable grid or matrix of magnetisable particles. Most preferably, the magnetisable element is a uniform matrix of metallic spheres forming a closely stacked lattice. This creates substantially uniform channels and thus uniform fluid flow and uniform separation results. Substances other than the target are also less likely to be trapped.

Such elements as described above provide a relatively large surface area (for example, in comparison with a solid magnetisable element) and allow the liquid to permeate through the magnetisable element, thus allowing efficient separation or capture of the particles.

The magnetisable element can be made of any material that can be magnetised, i.e. is magnetically susceptible. In one embodiment, the magnetisable element is pre-magnetised before it is inserted into the chamber. For example it may be made of a ferromagnetic material, such as iron, steel or cobalt nickel. However in a preferred embodiment, the magnetisable element is not pre-magnetised and the separation device further comprises a magnet to magnetise the magnetisable element once in place inside the chamber. The element will normally be magnetised at the time that it is desired to separate magnetic particles. Preferably, the magnetisable element is made of a paramagnetic or superparamagnetic material such that its magnetisation can be reduced or eliminated to allow the magnetic particles retained to be eluted. The magnet may be a permanent magnet or an electromagnet. In the case of a permanent magnet, it is preferably arranged such that it can be moved towards and away from the chamber in order to magnetise the element as desired. The magnet may take any shape.

As discussed above previously, the magnetisable element can be a matrix of spheres. These can be made of any metal which can be magnetised, i.e. which is magnetically susceptible. Preferably, however, they are made of a paramagnetic or superparamagnetic material. The size of the spheres may depend on the size of the target magnetic particles, with larger spheres being provided for the retention of larger particles. Increasing the size of the spheres improves the flow through the matrix, but reduces the magnetic flux density acting on the particles in the liquid and thus will be less efficient at retaining smaller, more weakly magnetised particles.

The liquid chamber may typically have a nozzle and the opening is disposed in the end of the nozzle. In use, this nozzle would be brought into contact with a liquid sample container. The nozzle allows the liquid to be more easily drawn in and expelled, and means that the liquid chamber body can be set some distance away from the liquid sample container so helping to avoid cross contamination. In one embodiment, the nozzle is removable and thus can be replaced as necessary to help avoid contamination of the different liquids in which it comes into contact. Preferably, the nozzle is downward facing.

The magnetisable element may be placed anywhere within the chamber, but is preferably placed above the opening. In the case in which a nozzle is provided, the magnetisable element may be placed directly above the entrance to the nozzle.

A retainer layer may be provided adjacent the magnetisable element on the opposite side of the magnetisable element to the opening in the chamber. This prevents the magnetisable element moving within the chamber whilst liquid is drawn in and expelled. Preferably, the retainer layer is made of a porous material to allow the liquid to flow therethrough.

In order to prevent the magnetisable element from entering the nozzle, a stopper may be provided. This may comprise a fluid permeable layer or a spherical element placed at the entrance to the nozzle from the main body of the chamber.

Preferably, the magnetisable element is coated with an impermeable plastic coating in order to prevent corrosion of the element, thus preventing damage to the element and the liquid in contact with the element. Any suitable coating may be used, but preferably it comprises polymers or lacquer. The coating also reduces nonspecific binding.

Such a coating or an additional coating may be applied to improve the physical stability of the element. In particular, this may be used to hold the particles of a matrix together. The coating may be a plastic coating or lacquer that polymerises and sets, shrinking as it does so to leave flow paths for the liquid. Thus, if the magnetisable element is so-coated, it may not be necessary to provide a retainer layer and/or a stopper. Also, the magnetisable element can be stuck to the walls of the chamber, in which case, neither a retainer layer nor a stopper would be necessary.

Liquid may be drawn into and expelled from the chamber by any known means. For example, the chamber may be made of a flexible material that can be compressed and released in order to draw in and expel liquid. In another embodiment, a vacuum line is arranged to draw liquid into and expel liquid from the chamber. Preferably, a piston is arranged to draw liquid into the chamber and expel liquid from the chamber. The piston may be disposed in the top of the chamber in the style of a syringe. The piston may therefore come into close contact with the liquid such that the piston acts on the liquid. Although the piston may contact the liquid directly, generally there will be a layer of air between the piston and the liquid so the piston does not directly touch the liquid. Such an apparatus is particularly suitable for handling liquid volumes from 1 ml to 50 ml.

Alternatively, the chamber may be connected by a flexible tube or other conduit to a piston disposed remote from the chamber. The piston is thereby arranged to remotely draw in and expel liquid from the chamber. Air may be present in the tube and would so prevent liquid coming into contact with the piston arrangement. This can help prevent contamination.

Preferably, a piston is operated automatically, for example by an electric motor.

Preferably, the chamber is made of a non-magnetic material, such as plastic, stainless steel or glass. The chamber can be of any desired size, and may depend on the size or concentration of the particles it is separating. For example if only a small sample is available, it is preferred to use a smaller chamber than if a large sample were available.

The magnetic separation device may be disposed of after each use. Alternatively, the device may be cleaned and re-used. In particular the chamber of the separation device may be disposed of and replaced after use.

A magnetic separation apparatus may comprise a plurality of magnetic separation devices. In one embodiment, a magnetic separation apparatus comprises a plurality of magnetic separation devices that are not each provided with a piston arranged to draw in and expel liquid from the chamber. Instead, the chambers of the separation devices are in fluid communication and a single piston is provided that is arranged to draw liquid into and expel liquid from the plurality of separation devices.

According to a second aspect, the present invention provides a pipette tip having an opening therein through which liquid may be drawn in and expelled, containing a magnetisable element for separating magnetic particles suspended in a liquid from the liquid. The magnetisable element may be a matrix of magnetic particles or may comprise fibres, in the same manner as the magnetic separation device of the first aspect.

In order to prevent the magnetisable element escaping through the opening, a stopper may be provided. This may for example comprise a fluid permeable layer or a spherical element placed over the opening. Alternatively or in addition, the magnetisable element may be coated with a plastic coating or lacquer to hold it together. This is particularly suitable when the magnetisable element comprises a number of particles. If the magnetisable element is so-coated, this may be sufficient to prevent it escaping through the opening, and thus a stopper may not be necessary.

Such a pipette tip can be attached by any known means to a conventional pipette. A conventional pipette may comprise a suction device such as a piston that is arranged to draw liquid into and expel liquid from the pipette tip. The pipette tip may preferably be able to handle liquid volumes of from 1 μl to 5 ml.

The present invention also provides a magnetic separation apparatus comprising a plurality of such pipette tips. Such a magnetic separation apparatus may comprise magnets to magnetise the magnetisable elements, as described in relation to the first aspect above. Each pipette tip may be removeably connected to a suction device arranged to draw liquid into and expel liquid from the pipette tip. The suction device may be, for example, a piston or a vacuum line. The pipette tip may be connected to the suction device via a conduit having air therein such that the liquid is separated from the suction device by the air.

Alternatively, a chamber may be provided with which the pipette tips are in fluid communication. A single suction device could be provided to act on the chamber thus drawing liquid into and expelling liquid from the pipettes.

The pipette tips may be used in a conventional liquid handling apparatus that uses removable pipette tips. The pipette tips may be changed and disposed after separation of a certain target material to prevent contamination of other samples. In order to be cost effective, the pipette tips may preferably be made of inexpensive materials.

By providing a plurality of magnetic separation devices or pipette tips a number of samples can be processed simultaneously, thus saving time and resources. More preferably, an electronic means is arranged to operate the magnetic separation devices automatically thus saving further time and resources and preventing the need for direct human operation. The magnetic separation apparatus may further comprise a sample holder having a plurality of wells disposed therein, a well being positioned adjacent the opening of each liquid chamber. In one preferred embodiment, ninety six wells are provided.

Once magnetic particles have been separated from a fluid and are held by the magnetisable element, they will generally need to be eluted from the separation device or pipette tip. Elution may be carried out in any known way. If it is desired to elute the magnetic particles (which will generally have a target material bonded thereto), elution may be achieved by releasing or reducing the magnetisation of the magnetisable element. Alternatively, the target material only may be eluted by applying a substance that breaks the bond between the target material and the magnetic particle. The target material can therefore be separated from the magnetic particle whilst the magnetic particle remains trapped by the magnetisable element.

In some circumstances it may be preferred to carry out some process on the magnetic particles prior to elution from the separation device. For example, staining of the target material may be carried out whilst the magnetic particles are bound to the magnetisable element.

The magnetic separation device and apparatus according to the present invention enable the isolation of a magnetically labelled target substance as described above. This isolation can form part of various inspection and analysis techniques such as chemiluminescence, fluoroluminescence, electrochemical illuminescence and immunological assay. Separated particles may then be suspended in an alternative fluid. The concentration of particles in a fluid can also be increased or decreased using the device of the invention.

It is often desired to clean particles that have been separated. The particles can be washed whilst they are held within the device by flushing cleaning liquid through the device. Alternatively, cleaning can be carried out by releasing separated particles into a cleaning liquid, agitating the cleaning liquid and then magnetically separating the particles once again. The cleaning liquid can then be poured away.

According to a third aspect, the present invention provides a method for separating magnetic particles from a liquid in which they are suspended, comprising: drawing the liquid through a nozzle into a chamber containing a magnetisable element and expelling the liquid out through the nozzle, wherein the magnetic particles are retained in the chamber by the magnetisable element.

The various features discussed in relation to the first aspect are also applicable to the second and third aspects.

Preferred embodiments of the present invention will now be described by way of example only and with reference to the accompanying drawings, in which:

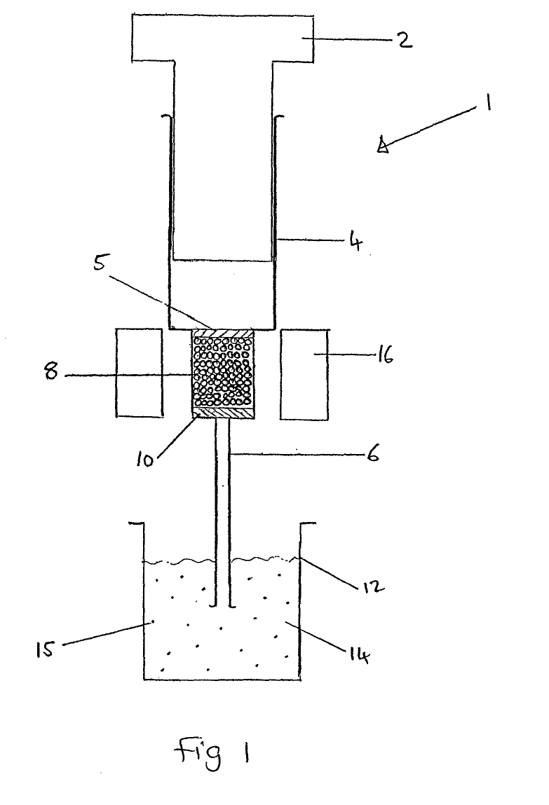

FIG. 1 illustrates a magnetic separation device according to one embodiment of the present invention.

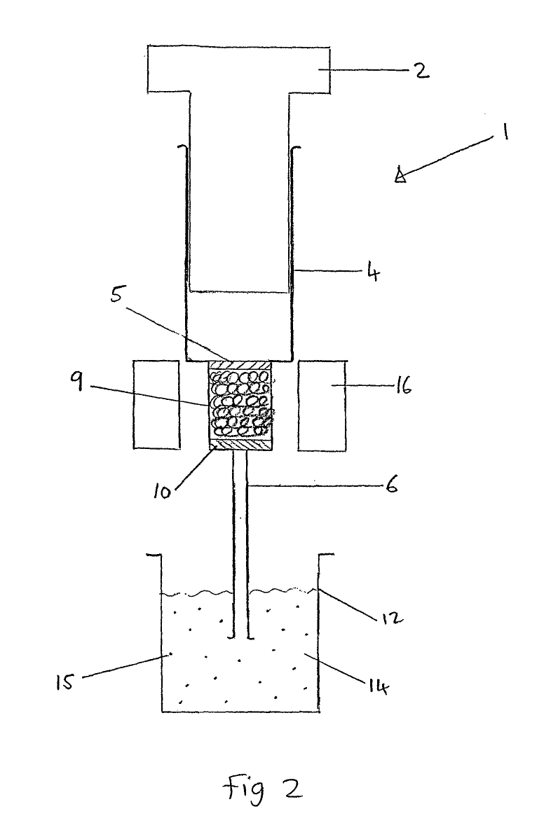

FIG. 2 illustrates a magnetic separation device according to a further embodiment of the present invention.

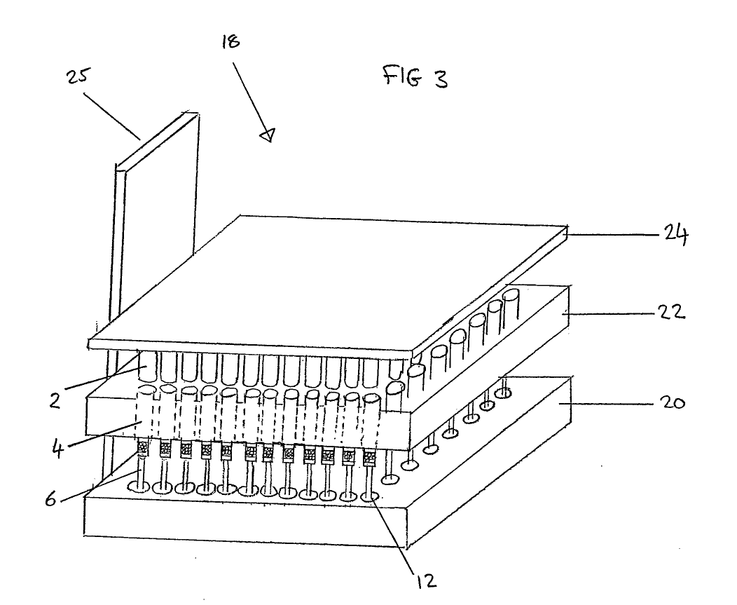

FIG. 3 illustrates a magnetic separation system comprising a number of magnetic separation elements according to an embodiment of the present invention.

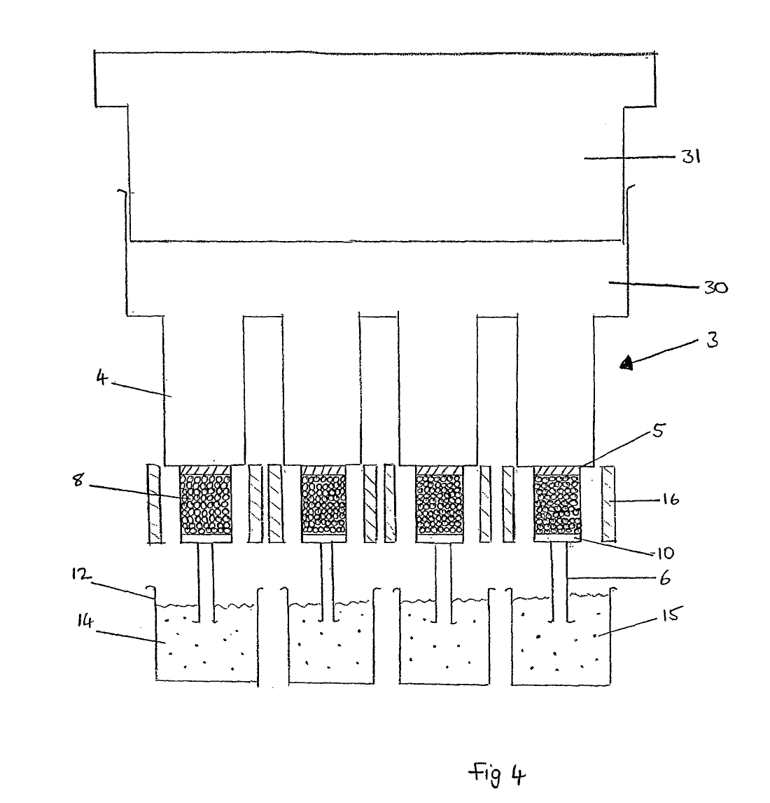

FIG. 4 illustrates a magnetic separation system according to a further embodiment of the present invention.

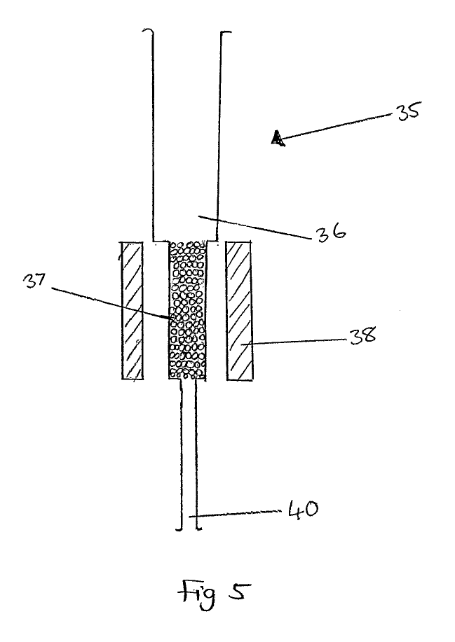

FIG. 5 illustrates a pipette tip according to an embodiment of the present invention.

FIG. 1 illustrates a magnetic separation element 1 generally in the form of a syringe. It has a tube 4 having a piston 2 slidably disposed in the top end thereof so that it can slide in and out of the tube. The bottom end of the tube narrows to a tubular nozzle portion 6 having an open end.

A plurality of magnetisable spheres 8 are provided within the tube 4 and form a uniform ‘matrix’. A top layer 5 made from nonmagnetic porous material is provided above the matrix to keep the spheres compacted together and prevent them moving upwards inside the tube 4. A porous stopper layer 10 is provided at the entrance to the nozzle portion 6 to prevent the spheres 8 flowing from the tube 4 through the nozzle portion 6 and out of the open end. The magnetisable spheres 8 can be magnetised as desired by magnet 16. The magnet 16 is a permanent magnet having a horseshoe shape thus partially surrounding the tube and can be moved in and out of position around the tube 4 to provide a magnetic field as desired. Alternatively, a magnetic field may be generated by winding coils of wire around the tube 4 and passing a current through the coils (not shown).

A sample container 12 holds a sample fluid 14. The sample fluid contains magnetic beads 15 having a target substance bonded thereto.

In use, the magnetisable spheres 8 are magnetised by magnet 16. The nozzle 6 of the tube 4 is placed into the sample fluid 14 contained in the sample container 12. The piston 2 is moved upwards within the tube 4, thus drawing fluid 14 into the tube 4 via nozzle 6. As the fluid 14 is drawn up through the matrix 8, the magnetic beads suspended in the sample are attracted and retained by the matrix 8. The piston is then moved downwards and the sample fluid is expelled from the nozzle 6. The magnetic beads 15 retained by the matrix 8 are thus separated from the fluid 14.

The magnetic beads can be retained by the matrix 8 whilst further fluids, for example a cleaning fluid, is drawn in through the nozzle 6, into the tube 4 and through the matrix thereby cleaning the beads retained therein.

A further magnetic separation device 3 is shown in FIG. 2. This is identical to the separation device 1 of FIG. 1 except that magnetisable wire wool 9 is disposed in the tube 4 to retain the magnetic beads, as opposed to the matrix of magnetisable spheres 8.

A number of separation devices 1, 3 can be combined into a magnetic separation system 18 shown in FIG. 3. In this embodiment, ninety-six separation elements are provided in a 12 x 8 configuration. Pistons 2 are held in piston holder 24, tubes 4 are retained in tube holder 22 and sample containers 12 are provided in sample holder 20. The piston holder 24 and tube holder 22 are moveable up and down on support 25. Sample holder 20 is horizontally moveable away from piston holder 24 and tube holder 22. The moving mechanisms for moving the holders can be any mechanisms known in the art, for example a manual mechanism or a DC motor. A coil of wire is arranged around each tube 4 (not shown) and these coils are connected to a power supply (not shown). When a current is supplied to the coils from the power supply, each coil forms a tiny electromagnet thus causing the magnetisable spheres 8 or wire wool 9 to be magnetised as desired. FIG. 3 shows the system in an extended position with pistons 2 held above tubes 4.

In use, the magnetisable particles 8 or wire wool 9 provided in the tubes 4 are magnetised by the coils wound on each tube 4. Piston holder 24 is raised to move pistons 2 upwards inside the tubes 4, thus drawing fluid 14 into the tubes 4 via nozzles 6. The magnetic beads are thus separated by matrix 8 or wire wool 9, and piston holder 24 is lowered to expel the residual fluid back into the sample containers 12. Sample holder 20 can then be moved horizontally away from the tube holder 22 if necessary and replaced with a different fluid holder to carry out a further process. For example, a cleaning fluid holder may be provided so that cleaning fluid can be drawn into and expelled from the tubes to clean the magnetic beads retained in the matrix 8 or wire wool 9. The magnetic beads can then be released by removing the current and thereby removing the magnetic field.

FIG. 4 illustrates an embodiment wherein a number of magnetic separation devices 3 having tubes 4 are in fluid communication with common chamber 30. A piston 31 is disposed in the top of common chamber 30 and acts on the fluid contained therein. When the piston 31 is moved upwards, fluid 14 is drawn through each tube 4 into common chamber 30. When the piston 31 is moved downwards, fluid 14 is expelled from common chamber 30 via tubes 4 and out through nozzles 6. As with the previously described embodiments, magnetic beads 15 suspended in fluid 14 will be retained by matrix 8.

FIG. 5 illustrates a pipette tip 35 according to an embodiment of the present invention. The pipette tip comprises a tube 36 having an opening 40 in the downward facing end. A plurality of magnetisable spheres 37 are provided within the tube 36 and form a uniform ‘matrix’. The spheres 37 are coated with plastic lacquer to hold them together and also prevent corrosion. The magnetisable spheres 37 are magnetised as desired by magnet 38.

The pipette tip 35 can be used in a conventional pipette device (not shown) by attaching the upper end of the tube 36 to the device. A plurality of pipette tips can also be used in a conventional liquid handling apparatus in order to process a number of samples simultaneously. In use, the opening 40 will be placed in contact with a sample liquid (not shown). A suction device in the pipette or liquid handling apparatus will draw in and expel liquid from the pipette tip through the opening 40. Magnetic beads suspended in the liquid will be retained by magnetisable spheres 37.

1. A magnetic separation device comprising a chamber having an opening therein, wherein the device is arranged to draw liquid into the chamber and expel liquid from the chamber through the opening, and wherein the liquid chamber contains a magnetisable element for separating magnetic particles suspended in a liquid from the liquid.

2. A magnetic separation device as claimed in claim 1, wherein the magnetisable element is a matrix of magnetisable particles.

3. A magnetic separation device as claimed in claim 2, wherein the matrix is a fluid-permeable matrix of paramagnetic, superparamagnetic or ferromagnetic spheres.

4. A magnetic separation device as claimed in claim 1, wherein the magnetisable element comprises wire wool.

5. A magnetic separation device as claimed in claim 1, further comprising a stopper arranged to prevent the magnetisable element escaping through the opening in the chamber.

6. A magnetic separation device as claimed in claim 1, wherein the liquid chamber has a nozzle and the opening is disposed in the end of the nozzle.

7. A magnetic separation device as claimed in claim 6, wherein the nozzle is downward facing.

8. A magnetic separation device as claimed in claim 1, further comprising a stopper arranged to prevent the magnetisable element from entering the nozzle.

9. A magnetic separation device as claimed in claim 1, further comprising a magnet that magnetises the magnetisable element.

10. A magnetic separation device as claimed in claim 1, wherein said magnet is an electromagnet.

11. A magnetic separation device as claimed in claim 1, wherein the magnetisable element is coated with a plastic coating.

12. A magnetic separation device as claimed in claim 1, further comprising a piston arranged to draw liquid into the chamber and expel liquid from the chamber.

13. A magnetic separation device as claimed in claim 12, wherein the piston is disposed in the top of the chamber above the liquid.

14. A magnetic separation device as claimed in claim 12, wherein the piston is arranged remotely from the chamber and is not in contact with the liquid.

15. A magnetic separation device as claimed in claim 1 wherein a vacuum line is arranged to draw liquid into and expel liquid from the chamber.

16. A magnetic separation apparatus comprising a plurality of magnetic separation devices as claimed in claim 1.

17. A magnetic separation apparatus comprising a plurality of magnetic separation devices as claimed in claim 1 wherein the chambers of the separation devices are in fluid communication, the apparatus further comprising a single piston arranged to draw liquid into and expel liquid from the chambers of the plurality of separation devices.

18. A pipette tip having an opening therein through which liquid may be drawn in and expelled, containing a magnetisable element for separating magnetic particles suspended in a liquid from the liquid.

19. A pipette tip as claimed in claim 18, wherein the magnetisable element is a matrix of magnetic particles.

20. A pipette tip as claimed in claim 19 wherein the matrix is a fluid-permeable matrix of paramagnetic, superparamagnetic or ferromagnetic spheres.

21. A pipette tip as claimed in claim 18, wherein the magnetisable element is filamentous.

22. A pipette tip as claimed in claim 18, further comprising a stopper arranged to prevent the magnetisable element escaping through the opening.

23. A pipette tip as claimed in claim 18, wherein the magnetisable element is coated with a plastic lacquer.

24. A magnetic separation apparatus comprising a plurality of pipette tips as claimed in claim 18.

25. A magnetic separation apparatus as claimed in claim 24 wherein each pipette tip is removeably connectable to a suction device arranged to draw in and expel liquid from the pipette tip.

26. A magnetic separation apparatus as claimed in claim 24, wherein the pipette tips are in fluid communication with a single chamber.

27. A magnetic separation apparatus as claimed in claim 26, wherein a single suction device is arranged to draw liquid into and expel liquid from the pipette tips.

28. A magnetic separation apparatus as claimed in claim 16 further comprising an electronic means arranged to operate the magnetic separation devices automatically.

29. A magnetic separation apparatus as claimed in claim 25 further comprising an electronic means arranged to operate the suction devices automatically.

30. A magnetic separation apparatus as claimed in claim 16 further comprising a sample holder having a plurality of wells disposed therein, a well being positioned adjacent the opening of each liquid chamber.

31. A magnetic separation apparatus as claimed in claim 30 wherein ninety six wells are provided.

32. A method for separating magnetic particles from a liquid in which they are suspended, comprising: drawing the liquid through a nozzle into a chamber containing a magnetisable element and expelling the liquid out through the nozzle, wherein the magnetic particles are retained in the chamber by the magnetisable element.
